(19) United States
(12) Patent Application Publication
(10) Pub. No.: US 2005/0160844 A1
(43) Pub. Date: Jul. 28, 2005

(54) Play-free transmission

(76) Inventor: Heerke Hoogenberg, B H Rijssen (NL)

Correspondence Address: WOOD, HERRON & EVANS, LLP, 2700 CAREW TOWER, 441 VINE STREET, CINCINNATI, OH, 45202, US

(21) Appl. No.: 10/497,506

(22) PCT Filed: Nov. 29, 2002
(86) PCT No.: PCT/NL02/00776

(30) Foreign Application Priority Data
Dec. 7, 2001 (NL) 1019522

(51) Int. Cl. F16H 21/12

(52) U.S. Cl. 74/63

(57) ABSTRACT

A mechanical transmission (1), comprising:—a first shaft (2)—a second shaft (3) wherein the first shaft and the second shaft are mutually connected via at least one push belt (8), which push belt (8) has a fixed position relative to the first and second shafts. The use of the push belt results in a play-free transmission, the transmission ratio of which can be easily modified.

The invention relates to a mechanical transmission, comprising:
a first shaft;
a second shaft.

There are different mechanical transmissions known which have a fixed transmission ratio. Among those which can be envisaged are a gear transmission, a chain transmission and a belt transmission. A frequently occurring drawback of such transmissions is that a certain play is present between the input shaft and the output shaft. In the conventional transmissions such play can be remedied by for instance arranging a tensioner. However, after much use of such a transmission, whereby wear occurs, it may be necessary to readjust such a transmission to make it free of play.

Conventional gear transmissions have the further drawback that they can normally be made free of play for only one rotation direction. As soon as the rotation direction is reversed, the play distance must first be cleared, whereby a free stroke occurs and no direct coupling is thus present between input and output shaft.

Finally, conventional transmissions have the drawback that they are designed for one fixed transmission ratio and cannot be modified, or only with difficulty. In a gear or chain transmission the transmission ratio thus depends on the number of teeth. It is not possible to increase or decrease the transmission ratio by for instance a few percent.

It is an object of the invention to alleviate or even obviate the above stated drawbacks and to provide a mechanical transmission which is free of play.

This is achieved with a mechanical transmission as according to the preamble, which is characterized in that the first shaft and the second shaft are mutually connected via at least one push belt, which push belt has a fixed position relative to the first and second shafts.

The advantage of a push belt, which normally consists of mutually abutting links, is that it forms a large contact surface with the first and second shafts. Because the push belt is further pressed together continuously due to its construction, all play is hereby removed automatically. In addition, the rotation direction of the first and second shafts is irrelevant in respect of the transmission being free of play.

The transmission ratio of such a mechanical transmission according to the invention can be adjusted in simple manner by changing the length of the push belt. The transmission ratio is easily changed by for instance inserting an additional link in the push belt. Fine adjustment of this transmission ratio is possible by replacing a link with a thicker or thinner link.

A fixed position of the push belt is understood to mean the following. The push belt is placed between the first and second shaft and has a determined peripheral shape. The push belt will begin to rotate when the shafts rotate. The peripheral shape of the push belt will however remain constant and, in some embodiments of the invention, rotate around a fixed point.

In the case of variable transmissions wherein a push belt is used, this is not at all the case. The position of the push belt can herein be varied, whereby not only does the peripheral shape of the push belt change but the point of rotation of the peripheral shape also displaces.

In one embodiment according to the invention the mechanical transmission further comprises:
a first friction body connected to the first shaft;
a second friction body connected to the second shaft;
a push belt arranged between the first and second friction bodies and being in contact therewith;
wherein the first and second friction bodies are arranged fixedly relative to each other in at least radial direction.

Such a transmission has a very simple construction.

In such a transmission the second friction body preferably has two dish-shaped surfaces which are directed toward each other and between which the push belt is placed. The first friction body can then engage on either the outer periphery of the push belt or the inner periphery of the push belt.

In a preferred embodiment a mechanical transmission according to the invention further comprises:
a first friction body arranged rotatably on an eccentric connected to the first shaft;
a fixedly arranged second friction body;
a third friction body arranged on the second shaft;
a first push belt arranged between the first and second friction bodies and being in contact therewith; and
a second push belt arranged between the first and third friction bodies and being in contact therewith.

Such a mechanical transmission according to the invention has the advantage that the range of the transmission ratio is exceptionally large. It is thus theoretically possible to vary the transmission ratio from 0 to infinity. This will be further explained with reference to the figure description.

In a preferred embodiment of such a transmission, the second and third friction bodies each comprise two dish-shaped surfaces which are directed toward each other and between which the respective push belt is placed.

In another preferred embodiment the first friction body engages on the peripheral surface of both push belts.

In yet another embodiment according to the invention the first push belt has a length differing from that of the second push belt. A transmission ratio other than 1 can hereby be realized.

These and other features of the invention are further elucidated with reference to the annexed drawings.

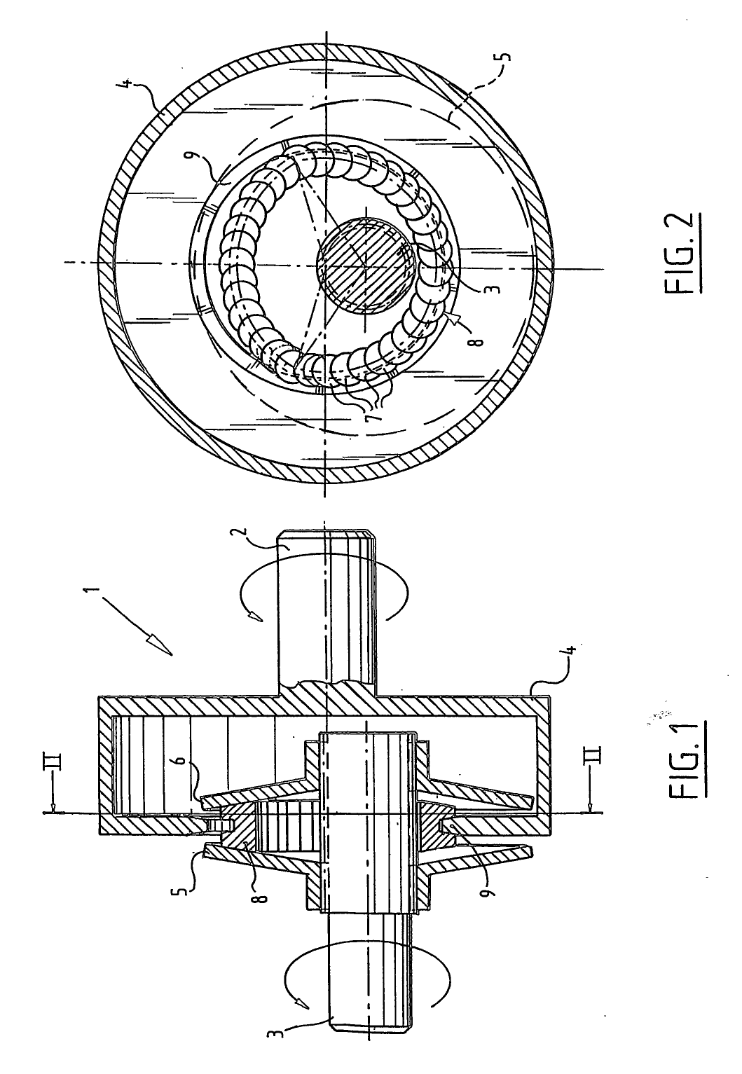

FIG. 1 shows a first embodiment of a mechanical transmission according to the invention.

FIG. 2 is a cross-sectional view of the embodiment of FIG. 1.

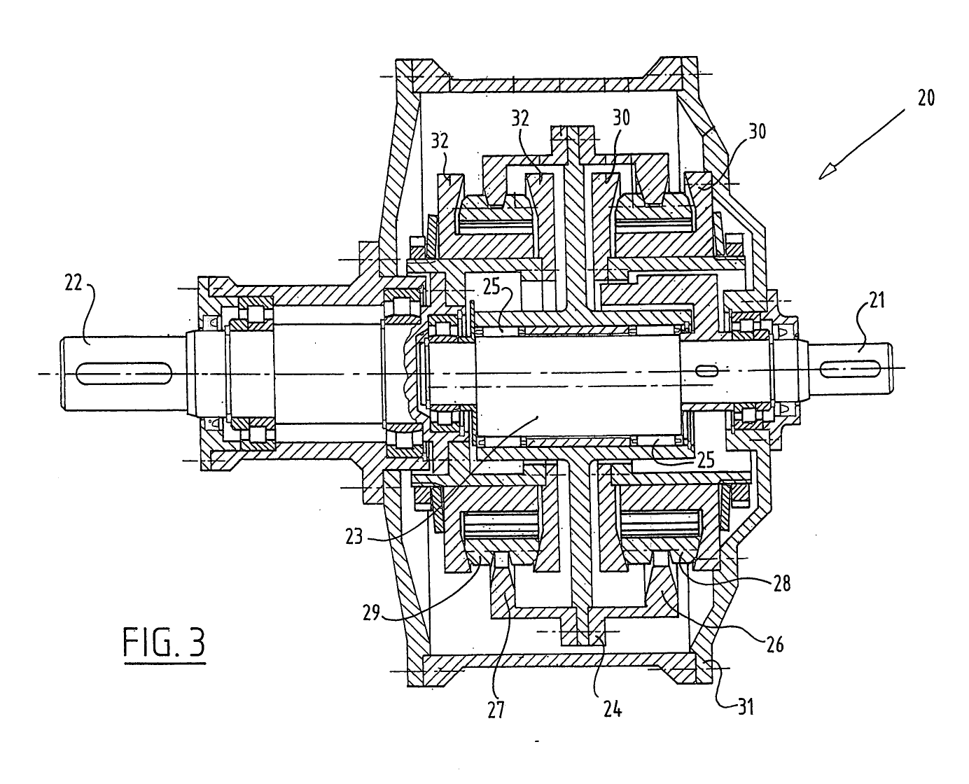

FIG. 3 is a cross-sectional view of a second embodiment of a mechanical transmission according to the invention.

FIG. 1 shows a cross-sectional view of a mechanical transmission 1 according to the invention. This mechanical transmission 1 has an input shaft 2 and an output shaft 3. On input shaft 2 is arranged a first friction body 4. On the output shaft is arranged a second friction body consisting of two dish-shaped discs 5, 6. A push belt 8 consisting of separate links 7 is arranged between these two dish-shaped discs 5, 6 (see also FIG. 2). The first friction body 4 has an edge 9 which engages on the outer peripheral surface of push belt 8.

FIG. 2 shows a cross-section of the device of FIG. 1. Shown here is the peripheral shape of push belt 8. In this FIG. 2 the upper part of push belt 8 has a larger radius than the lower part of push belt 8. This is because the upper part of push belt 8 lies against the dish-shaped discs 5, 6, while the lower part of push belt 8 lies against the edge 9 of the first friction body 4. This difference in radius of the upper part of the push belt and the lower part of the push belt forms the transmission ratio between input shaft 2 and output shaft 3. In this embodiment of the mechanical transmission according to the invention the peripheral shape of push belt 8 will remain as it is shown in FIG. 2. Links 7 of the push belt will however move around in this peripheral shape. Push belt 8 thus has a fixed position.

FIG. 3 shows a second embodiment 20 of a mechanical transmission according to the invention. This mechanical transmission 20 has an input shaft 21 and an output shaft 22. An eccentric 23 is arranged on input shaft 21. A first friction body 24 is arranged on this eccentric. This first friction body 24 is mounted for free rotation on eccentric 23 by bearings 25. The first friction body 24 has a first edge 26 and a second edge 27. The first edge 26 engages on a first push belt 28 and the second edge 27 engages on a second push belt 29.

The first push belt 28 is arranged between two dish-shaped discs 30 forming the second friction body. These dish-shaped discs 30 are arranged fixedly on housing 31 of mechanical transmission 20.

The second push belt 29 is arranged between dish-shaped discs 32. These dish-shaped discs 32 form the third friction body and are coupled directly to output shaft 22.

When input shaft 21 is now driven, the first friction body 24 will begin to displace in a circular path as a consequence of eccentric 23. Through this circular displacement the first friction body 24 will contact the first push belt 28 at different positions along the periphery by means of the first edge 26. The push belt is hereby pressed together, whereby the peripheral shape of the first push belt rotates in this. Because the first push belt lies on one side against the fixed dish-shaped discs 30 and on the other side is in continuous contact with a part of the first edge 26, the first friction body 24 will be made to rotate around eccentric 23. The first friction body 24 also engages by means of the second edge 27 on the second push belt 29 and also deforms it. As a result of this deformation the output shaft 22 will also begin to rotate. Because the first push belt 28 makes the first friction body 24 rotate, this provides acceleration or deceleration of the output shaft 22. With a suitable choice of the length of the second push belts 28, 29, which may also differ from each other, a desired transmission ratio can thus be adjusted. It is even possible to give output shaft 22 a rotation direction opposite that of input shaft 21.

1. Mechanical transmission, comprising:
a first shaft;
a second shaft;
characterized in that
the first shaft and the second shaft are mutually connected via at least one push belt, which push belt has a fixed position relative to the first and second shafts.

2. Mechanical transmission as claimed in claim 1, further comprising:
a first friction body connected to the first shaft;
a second friction body connected to the second shaft;
a push belt arranged between the first and second friction bodies and being in contact therewith;
wherein the first and second friction bodies are arranged fixedly relative to each other in at least radial direction.

3. Mechanical transmission as claimed in claim 2, wherein the second friction body comprises two dish-shaped surfaces which are directed toward each other and between which the push belt is placed.

4. Mechanical transmission as claimed in claim 1, further comprising:
a first friction body arranged rotatably on an eccentric connected to the first shaft;
a fixedly arranged second friction body;
a third friction body arranged on the second shaft;
a first push belt arranged between the first and second friction bodies and being in contact therewith; and
a second push belt arranged between the first and third friction bodies and being in contact therewith.

5. Mechanical transmission as claimed in claim 4, wherein the second and third friction bodies each comprise two dish-shaped surfaces which are directed toward each other and between which the respective push belt is placed.

6. Mechanical transmission as claimed in claim 4 or 5, wherein the first friction body engages on the peripheral surface of both push belts.

7. Mechanical transmission as claimed in any of the claims 4-6, wherein the first push belt has a length differing from that of the second push belt.
